(19) United States
(12) Patent Application Publication
(10) Pub. No.: US 2025/0330588 A1
(43) Pub. Date: Oct. 23, 2025

(54) MULTI-TEMPLATE DECODER SIDE INTRA MODE DERIVATION

(71) Applicant: Tencent America LLC, Palo Alto, CA (US)

(72) Inventors: Yonguk YOON, Palo Alto, CA (US); Biao WANG, San Jose, CA (US); Lien-Fei CHEN, Palo Alto, CA (US); Roman CHERNYAK, Santa Clara, CA (US); Yifan WANG, Palo Alto, CA (US); Ziyue XIANG, Palo Alto, CA (US); Tianqi LIU, Palo Alto, CA (US); Motong XU, Palo Alto, CA (US); Shan LIU, San Jose (CA)

(73) Assignee: Tencent America LLC, Palo Alto, CA (US)

(21) Appl. No.: 19/182,446

(22) Filed: Apr. 17, 2025

Related U.S. Application Data
(60) Provisional application No. 63/636,651, filed on Apr. 19, 2024.

(51) Int. Cl. H04N 19/11; H04N 19/105; H04N 19/174; H04N 19/176

(52) U.S. Cl. CPC H04N 19/11; H04N 19/105; H04N 19/174; H04N 19/176

(57) ABSTRACT

Some aspects of the disclosure provide a method of video decoding. In an example, a coded video bitstream is received, the coded video bitstream includes coded information of a current block in a current picture, the coded information indicates that the current block is coded using multiple template decoder side intra mode derivation. A template is selected from one or more predefined templates based on a syntax element that is decoded from the coded information of the current block. One or more intra prediction modes are determined based on the template. The current block is reconstructed based on the one or more intra prediction modes.

### INCORPORATION BY REFERENCE

The present application claims the benefit of priority to U.S. Provisional Application No. 63/636,651, filed on Apr. 19, 2024. The entire disclosure of the prior application is hereby incorporated by reference in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video decoding. In an example, a coded video bitstream is received, the coded video bitstream includes coded information of a current block in a current picture, the coded information indicates that the current block is coded using multiple template decoder side intra mode derivation. A template is selected from one or more predefined templates based on a syntax element that is decoded from the coded information of the current block. One or more intra prediction modes are determined based on the template. The current block is reconstructed based on the one or more intra prediction modes.

Some aspects of the disclosure provide a method for video encoding. In an example, to code a current block in a current picture using multiple template decoder side intra mode derivation is determined. A template is selected from one or more predefined templates. One or more intra prediction modes are determined based on the template. Coded information of the current block is generated based on the one or more intra prediction modes. A syntax element is included into the coded information of the current block, the syntax element is indicative of the selected template from the one or more predefined templates.

Some aspects of the disclosure provide a method of processing visual media data is provided. In the method, a conversion between a visual media file and a bitstream of visual media data is performed according to a format rule. In an example, the bitstream includes coded information of a current block in a current picture, the coded information indicates that the current block is coded using multiple template decoder side intra mode derivation. The format rule specifies that a template is selected from one or more predefined templates based on a syntax element in the coded information of the current block; one or more intra prediction modes is determined based on the template; and the current block is reconstructed based on the one or more intra prediction modes.

Aspects of the disclosure also provide an apparatus for video decoding. The apparatus for video encoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system.

FIG. 2 is a schematic illustration of an example of a block diagram of a decoder.

FIG. 3 is a schematic illustration of an example of a block diagram of an encoder.

FIG. 4 shows a diagram of intra prediction modes in some examples.

FIG. 5 shows another diagram of intra prediction modes in some examples.

FIG. 6 shows an example of using a decoder-side intra mode derivation (DIMD) mode for a prediction of a current block in some examples.

FIGS. 7A-7D show examples of histograms of gradients for different templates of a current block (701) in an example.

FIGS. 8A-8B show diagrams of templates for a current block in some examples.

FIGS. 9A-9D shows examples of the templates corresponding to the selected multi-reference-line in some examples.

FIGS. 10A-10D shows examples of the templates corresponding to the selected multi-reference-line in some examples.

FIG. 11 shows a flow chart outlining a decoding process according to some aspects of the disclosure.

FIG. 12 shows a flow chart outlining an encoding process according to some aspects of the disclosure.

FIG. 13 is a schematic illustration of a computer system in accordance with an aspect.

### DETAILED DESCRIPTION

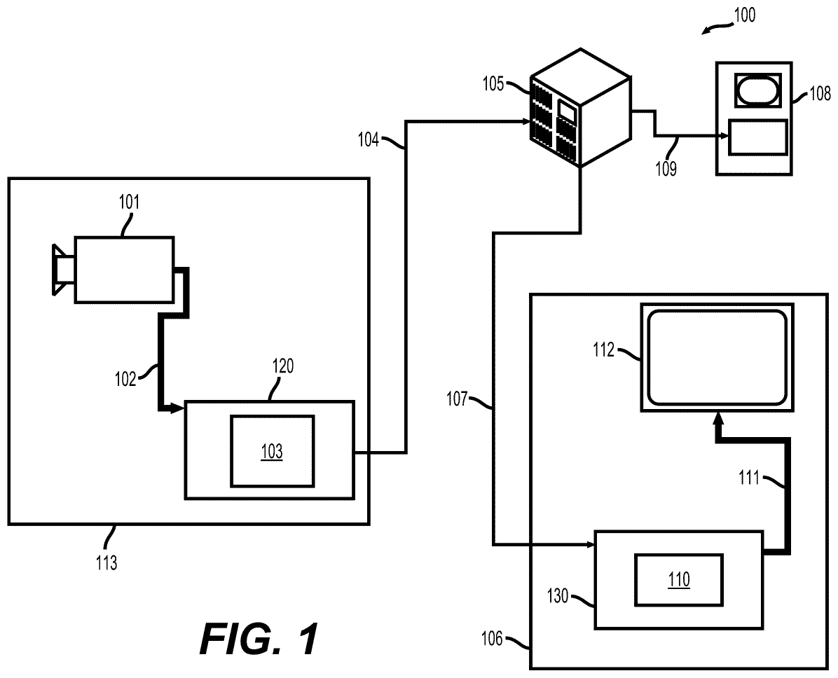

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

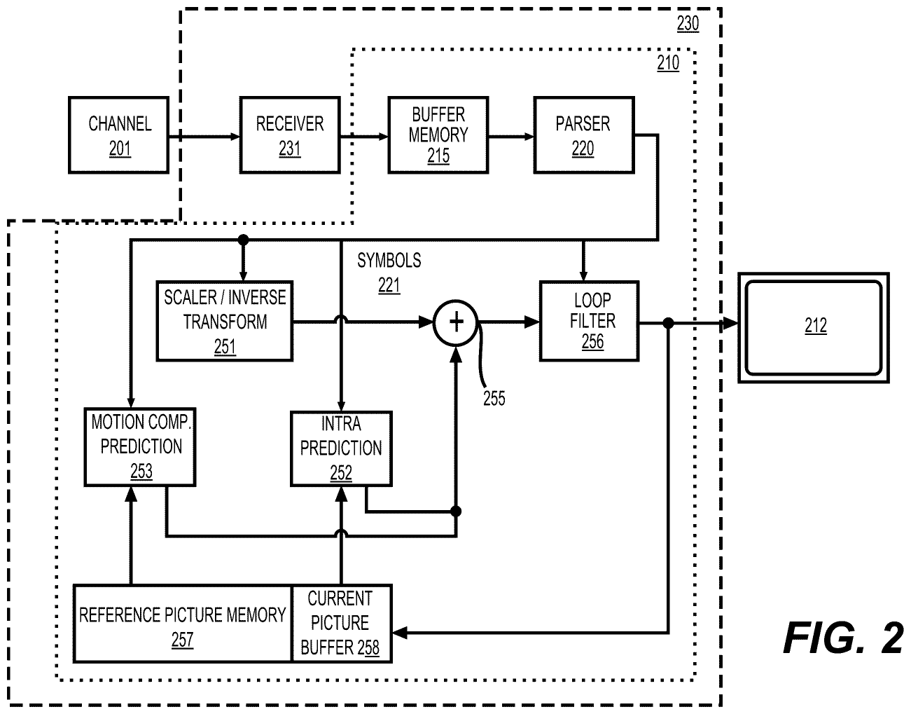

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

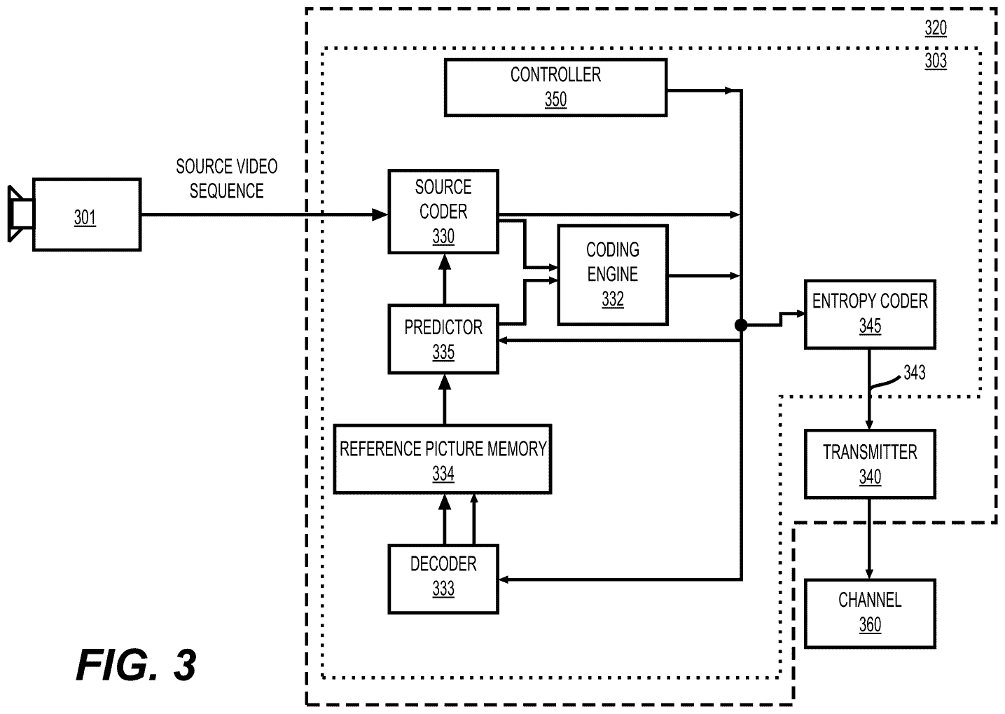

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques (e.g., methods, embodiments, encoders, decoders) for decoder side intra mode derivation, such as multi-template decoder side intra mode derivation. The techniques in the present disclosure may be used separately or combined in any order. Further, each of the techniques may be implemented by processing circuitry (e.g., one or more processors or one or more integrated circuits). In one example, the one or more processors execute a program that is stored in a non-transitory computer-readable medium.

Video coding has been widely used in many applications. Video coding standards, such as H264, H265, H266 (VVC), AV 1 and AVS, can be adopted in video codec for video coding.

Intra prediction techniques can be used video and/or image coding to use reference data from a current picture under reconstruction for sample prediction. Intra prediction modes are used in some intra prediction techniques.

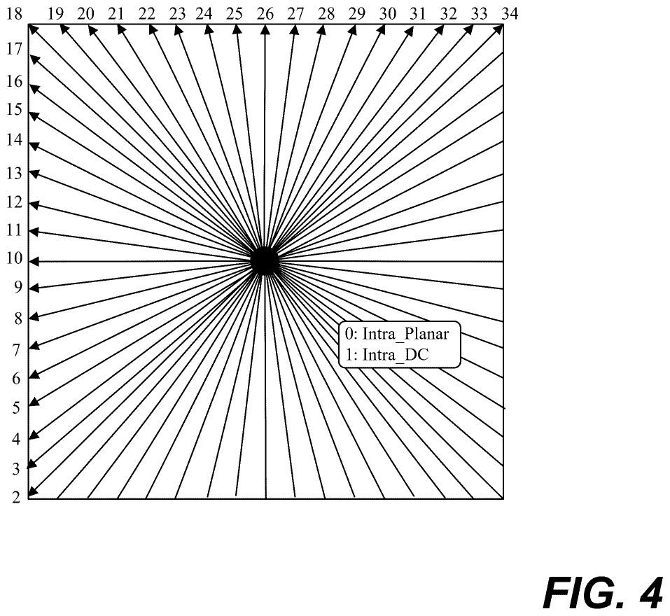

FIG. 4 shows a diagram of intra prediction modes in some examples, such as HEVC. For example, HEVC uses a total of 35 intra prediction modes (e.g., mode 0 to mode 34). Among the 35 intra prediction modes, some modes are directional modes and some modes are non directional modes. In some examples, mode 0 and mode 1 are non directional modes, for example, mode 0 is a planar mode, and mode 1 is DC mode. Further, mode 2 to mode 34 can be directional modes, for example, mode 10 is horizontal mode, mode 26 is vertical mode, and mode 2, mode 18 and mode 34 are diagonal modes, and the like. Values of samples in a coding block are determined according to the neighboring references samples in the same picture and the intra prediction mode of the coding block. In an example, in the DC mode, a mean value is calculated by averaging reference samples in the same picture and can be used for flat surfaces. In another example, in the planar mode, the value of each sample in the coding block is calculated assuming an amplitude surface with a horizontal and vertical smooth gradient derived from the boundaries samples of the neighboring blocks. In some examples, the reference samples include neighboring samples in a row immediately above the coding block and/or include neighboring samples in a column immediately left of the coding block.

In some examples, the intra prediction modes are signaled based on a list of most probable modes (MPMs), and remaining modes. For example, for a coding block, an MPM list is determined. In an example, the MPM list includes 3 modes from the 35 intra prediction modes. Then, when the specific intra prediction mode of the coding block is one of the 3 modes in the MPM list, an index indicative of the one of the 3 modes is used for signaling. When the specific intra prediction mode of the coding block is not one of the 3 modes in the MPM list, an index indicative of one from the remaining modes (32 modes) is used for signaling. In some examples, the MPM list can include other suitable number of modes, such as 6, 10, and the like.

It is noted other suitable number of intra prediction modes can be used.

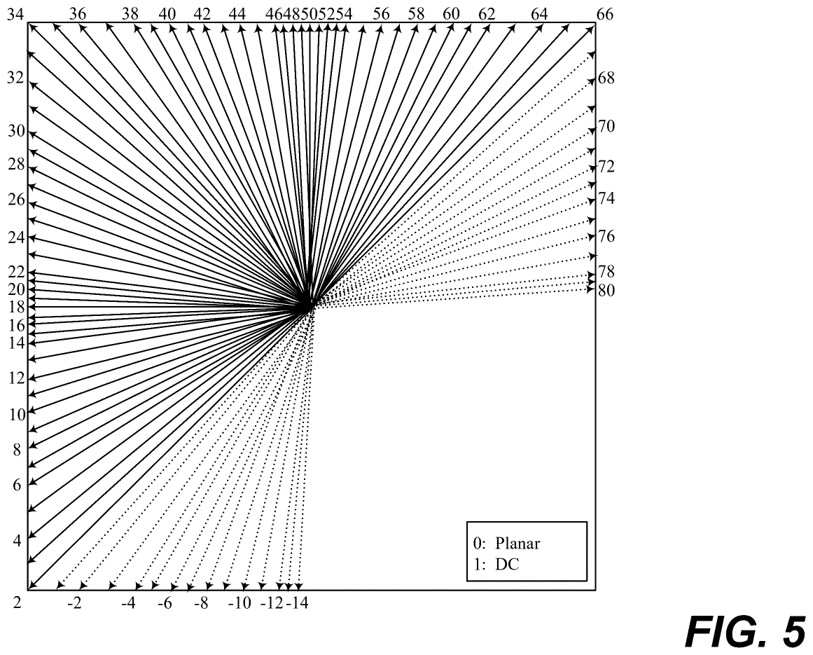

FIG. 5 shows a diagram of intra prediction modes in some examples, such as VVC. In some examples, VVC can use a total of 95 intra prediction modes, such as mode −14 to mode 80. Among the 95 intra prediction modes, mode 0 is a planar mode, mode 1 is DC mode, mode 18 is horizontal mode, mode 50 is vertical mode, and mode 2, mode 34 and mode 66 are diagonal modes. Modes −1 to −14 and modes 67 to 80 are referred to wide-angle intra prediction (WAIP) modes in some examples.

In some examples, to code an intra mode (also referred to as intra prediction mode) of a coding block (e.g., a luma block, chroma blocks of a coding unit), a most probable mode (MPM) list of size 3 is built based on the intra modes of the neighboring blocks of the coding block. The MPM list can be referred to as the MPM list or primary MPM list. If the intra mode of the coding block is not from the MPM list, a flag is signaled to indicate whether intra mode belongs to the selected modes in the MPM list.

In some examples, when an intra prediction mode of a current block is determined, samples in the current block can be generated based on reference samples, such as neighboring samples that already reconstructed.

Intra prediction explores spatial redundancy between a current block and neighboring samples of the current block. For example, to code a block using intra prediction, multiple intra prediction modes may be defined, and a selection of one of the multiple intra prediction modes may be predicted and further signaled. Different intra prediction modes may generate prediction sample values using different predefined models. The different predefined models may include (1) averaging neighboring samples, (2) interpolating the prediction samples using neighboring samples with a given prediction direction, such as in an angular intra prediction mode, and the like to predict a sample in the current block. In some examples, due to the correlation of spatial textures in image and/or video content, intra prediction modes selected for adjacent blocks may be highly correlated. Accordingly, intra prediction mode(s) of the current block may not need to be signaled. Instead, the intra prediction mode(s) of the current block may be derived by analyzing a template of the current block.

According to an aspect of the disclosure, in order to reduce the signaling overhead, decoder-side intra prediction mode derivation techniques can use template cost-based intra prediction mode derivation and decoder-side gradient based intra prediction mode derivation. For example, the gradient-based intra mode derivation generates a histogram of gradients using adjacent neighboring samples of the current block. Based on the histogram, the top N gradients are mapped to intra mode, and those predictors are combined as a final predictor in an example. In some examples, the derived intra prediction modes can be included in the MPM list.

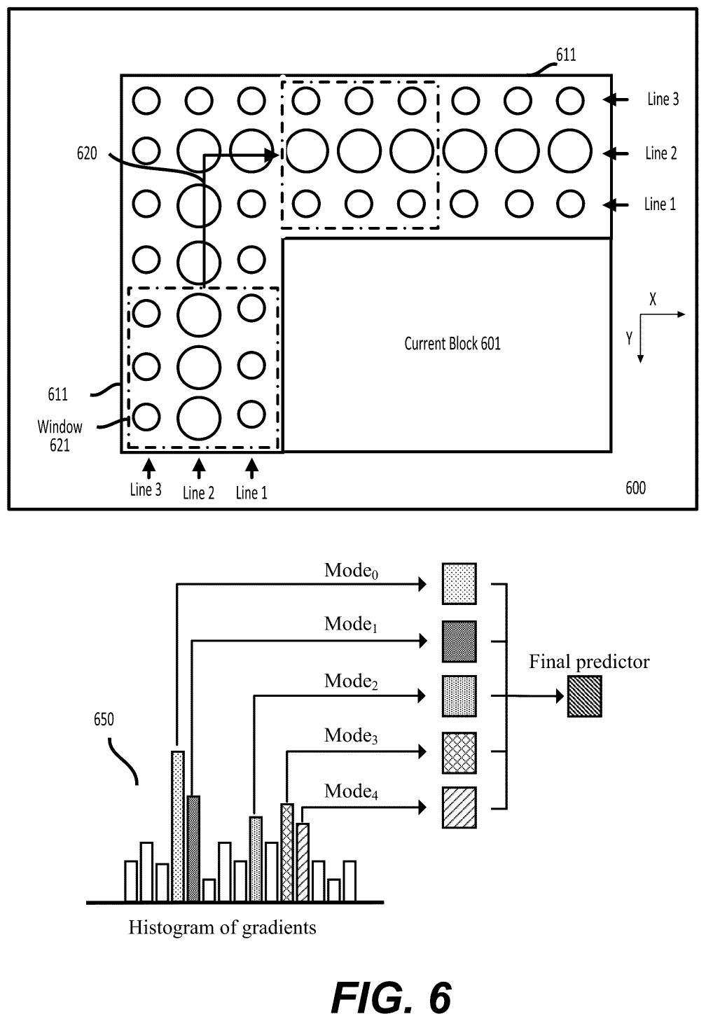

FIG. 6 shows an example of using a decoder-side intra mode derivation (DIMD) mode for a reconstruction of a current block. In the FIG. 6 example, a current block (601) in a current picture can be coded in a DIMD mode, one or more intra prediction modes are derived based on reconstructed samples (also referred to as reconstructed neighboring samples) in a template (611) of the current block (601), and the one or more intra prediction modes can be used to predict the current block (601).

In some examples, to derive the one or more intra prediction modes, gradients of samples in the template (611) are calculated, and a histogram of the gradients is used to derive the one or more intra prediction modes.

In an example, filter(s) (e.g., a Sobel filter) can be used to calculate the gradients in the template (611). For example, a horizonal Sobel 3×3 filter and a vertical Sobel 3×3 filter are applied on a window of 3×3 samples at a position (such as shown by window (621) in FIG. 6) to calculate a horizonal gradient Gx and vertical gradient Gy of the 3×3 samples associated with the position of the template (611). In an example, the window (621) can slide across the template (611) as shown by (620) in FIG. 6 to various positions, to calculate gradients associated with various positions in the template (611).

In some examples, a histogram of the gradients is constructed based on the reconstructed samples in the template (611). From the histogram, one or more dominant gradients can be matched to one or more intra prediction modes.

In the FIG. 6 example, a histogram of gradients (650) is constructed based on gradients associated with positions in the template (611). A gradient at a position is indicated as a radio of the horizonal gradient Gx and the vertical gradient Gy in an example.

Further, in the FIG. 6 example, five most frequent gradients are determined based on the histogram of gradients (650), the five most frequent gradients are respectively matched to five intra prediction modes. In an example, a final predictor is generated based on the five intra prediction modes.

According to some aspects of the disclosure, when the histogram of gradients is constructed based on a template, then different templates may result to different histograms, and derived intra prediction modes can be different for different templates.

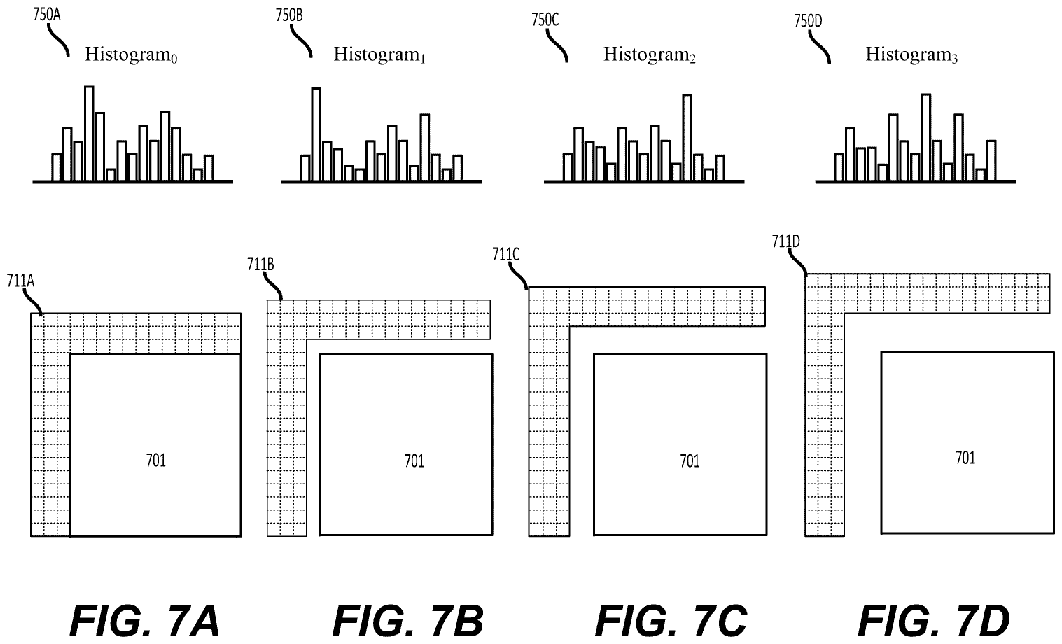

FIGS. 7A-7D show examples of histograms for different templates of a current block (701) in an example.

FIG. 7A shows a template (711A) of the current block (701), and a histogram of gradients (750A) that is constructed based on the template (711A).

FIG. 7B shows a template (711B) of the current block (701), and a histogram of gradients (750B) that is constructed based on the template (711B).

FIG. 7C shows a template (711C) of the current block (701), and a histogram of gradients (750C) that is constructed based on the template (711C).

FIG. 7D shows a template (711D) of the current block (701), and a histogram of gradients (750D) that is constructed based on the template (711D).

As shown in the FIGS. 7A-7D, the histograms (750A)-(750D) have different most frequent gradients that can match to different intra prediction modes.

The present disclosure provides techniques for a multi-template decoder-side intra mode derivation. When multiple templates are used in the decoder side intra mode derivation, image quality can be improved by a selected of a better matching intra prediction mode from more potential intra prediction modes. In some examples, the encoder can signal an index indicative of a template from one or more predefined templates to the decoder, and the decoder can select the template according to the index. The encoder/decoder can determine one or more intra prediction modes based on the template; and reconstruct the current block based on the one or more intra prediction modes.

According to an aspect of the disclosure, a template is selected from a predefined number of templates, and a histogram of gradients is computed from the selected template, a template index is signaled to indicate which template is selected.

In some examples, the number of predefined templates can be at least one.

In some examples, when plural templates are available, the template areas of different templates can overlap. In some examples, when plural templates are available, the template areas of different templates cannot overlap.

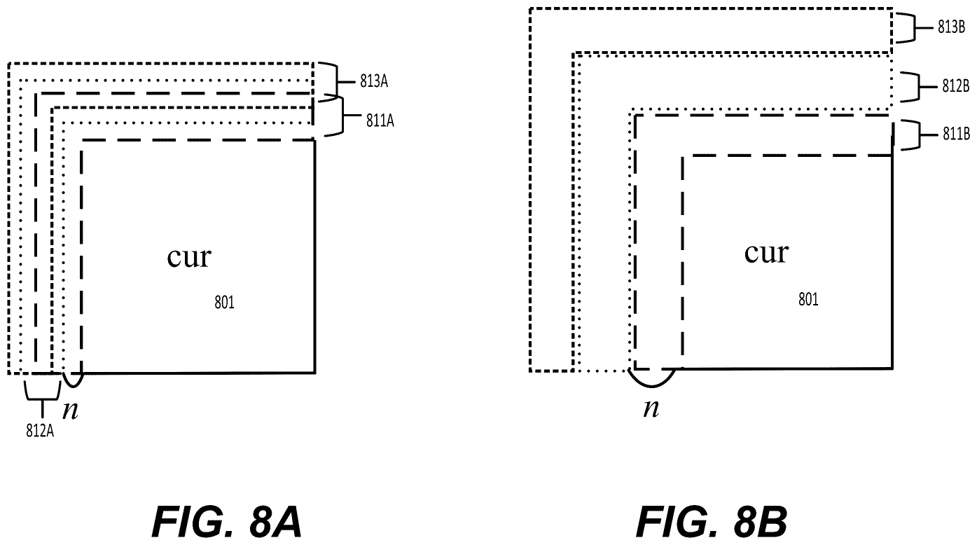

FIGS. 8A-8B show diagrams of templates for a current block in some examples. In the FIG. 8A example, templates areas of different of different templates, such as template (811A), template (812A) and template (813A), are overlapped. In the FIG. 8B example, templates areas of different of different templates, such as template (811B), template (812B) and template (813B) do not overlap.

In some examples, the gap (denoted by n) between templates can differ. In an example, a first gap between a first template and a second template is 1, and a second gap between the second template and the third template is 2.

In some aspects, the derived intra prediction mode from a selected template can be used for other coding tools.

For example, the derived intra prediction mode from a selected template can be used to determine a transform set. In some examples, a predefined table is used to determine the transform set based on the derived intra prediction mode. The predefined table is configured to map intra prediction modes to transform sets.

In an example, the derived intra prediction mode is used to determine a primary transform set. In another example, the derived intra prediction mode is used to determine a secondary transform set.

In some examples, the derived intra prediction mode from a selected template can be used to determine a direct mode for chroma prediction mode. For example, an intra prediction mode is derived based on luma samples of a selected template, the derived intra prediction mode can be used as a chroma prediction mode that is used to predict the chroma samples of the current block.

In some examples, the derived intra prediction mode from a selected template can be used to predict an intra predictor for the combined inter-intra predictor. In an example, the current block is coded in a combined inter-intra prediction (CIIP) mode that is predicted as a combination of an inter predictor and an intra predictor. The derived intra prediction mode from the selected template can be used to generate an intra predictor for the CIIP mode.

According to some aspects of the disclosure, a multi-reference-line index is utilized to signal template index implicitly. Some coding tools signal an index (also referred to as multiple-reference-line index) that indicates a selected reference line from multiple reference lines. In some examples, the multi-reference-line index is used to derive the selected template. In an example, when an intra prediction mode is derived from the template corresponding to the selected multi-reference-line index, the intra prediction mode can be put into the most probable mode (MPM) list.

In some aspects, the number of predefined templates can be equal to or less than the number of multi-reference-lines. In an example, the predefined templates correspond to different reference lines in the multi-reference-lines.

In some aspects, a template corresponding to a selected multi-reference-line can be configured in various ways depending on the position of the multi-reference-line with regard to the template.

In some examples, the first line (e.g., nearest line to the current block) in the template corresponds to a selected reference line from multiple reference lines.

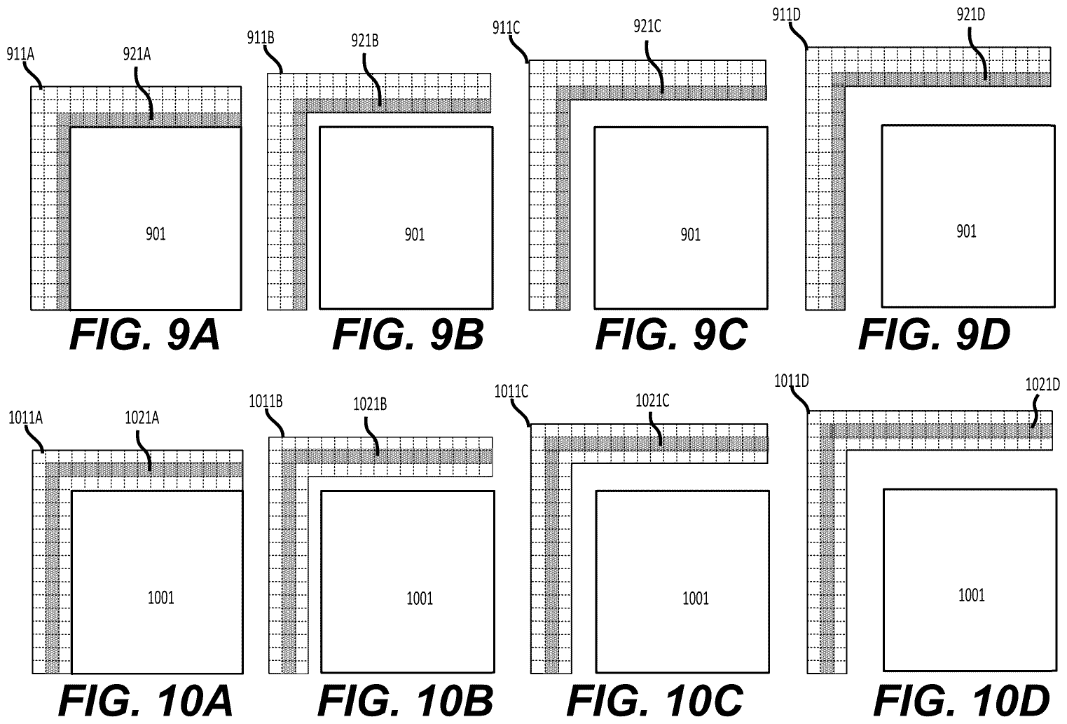

FIGS. 9A-9D shows examples of the templates corresponding to the selected multi-reference-line in some examples. In the FIGS. 9A-9D example, the first line of the template corresponds to the selected multi-reference-line. For example, in FIG. 9A, when the multi-reference-line index of the current block (901) indicates the multi-reference-line (921A), then the template (911A) corresponding to the multi-reference-line (921A) is used to derive one or more intra prediction modes (e.g., according to histogram of gradients in the template). The one or more intra prediction modes can be inserted in the MPM list in an example. Also, in an example, after an intra prediction mode from the MPM list is determined for coding the current block (901), the current block (901) is predicted based on the intra prediction mode from the MPM lost and the multi-reference-line (921A).

In the FIG. 9B example, when the multi-reference-line index of the current block (901) indicates the multi-reference-line (921B), then the template (911B) corresponding to the multi-reference-line (921B) is used to derive one or more intra prediction modes (e.g., according to histogram of gradients in the template). The one or more intra prediction modes can be inserted in the MPM list in an example. Also, in an example, after an intra prediction mode from the MPM list is determined for coding the current block (901), the current block (901) is predicted based on the intra prediction mode from the MPM lost and the multi-reference-line (921B).

In the FIG. 9C example, when the multi-reference-line index of the current block (901) indicates the multi-reference-line (921C), then the template (911C) corresponding to the multi-reference-line (921C) is used to derive one or more intra prediction modes (e.g., according to histogram of gradients in the template). The one or more intra prediction modes can be inserted in the MPM list in an example. Also, in an example, after an intra prediction mode from the MPM list is determined for coding the current block (901), the current block (901) is predicted based on the intra prediction mode from the MPM lost and the multi-reference-line (921C).

In the FIG. 9D example, when the multi-reference-line index of the current block (901) indicates the multi-reference-line (921D), then the template (911D) corresponding to the multi-reference-line (921D) is used to derive one or more intra prediction modes (e.g., according to histogram of gradients in the template). The one or more intra prediction modes can be inserted in the MPM list in an example. Also, in an example, after an intra prediction mode from the MPM list is determined for coding the current block (901), the current block (901) is predicted based on the intra prediction mode from the MPM lost and the multi-reference-line (921D).

In some examples, the second line (e.g., middle line) of the template can correspond to selected reference line (also referred to as multi-reference-line) from multiple reference lines. In some examples, one or more intra modes derived from the corresponding template can be included in the most probable mode (MPM) list.

FIGS. 10A-10D shows examples of the templates corresponding to the selected multi-reference-line in some examples. In the FIGS. 10A-10D example, the second line (e.g., middle line) of the template corresponds to the selected multi-reference-line. For example, in FIG. 10A, when the multi-reference-line index of the current block (1001) indicates the multi-reference-line (1021A), then the template (1011A) corresponding to the multi-reference-line (1021A) is used to derive one or more intra prediction modes (e.g., according to histogram of gradients in the template). The one or more intra prediction modes can be inserted in the MPM list in an example. Also, in an example, after an intra prediction mode from the MPM list is determined for coding the current block (1001), the current block (1001) is predicted based on the intra prediction mode from the MPM lost and the multi-reference-line (1021A).

In the FIG. 10B example, when the multi-reference-line index of the current block (1001) indicates the multi-reference-line (1021B), then the template (1011B) corresponding to the multi-reference-line (1021B) is used to derive one or more intra prediction modes (e.g., according to histogram of gradients in the template). The one or more intra prediction modes can be inserted in the MPM list in an example. Also, in an example, after an intra prediction mode from the MPM list is determined for coding the current block (1001), the current block (1001) is predicted based on the intra prediction mode from the MPM lost and the multi-reference-line (1021B).

In the FIG. 10C example, when the multi-reference-line index of the current block (1001) indicates the multi-reference-line (1021C), then the template (1011C) corresponding to the multi-reference-line (1021C) is used to derive one or more intra prediction modes (e.g., according to histogram of gradients in the template). The one or more intra prediction modes can be inserted in the MPM list in an example. Also, in an example, after an intra prediction mode from the MPM list is determined for coding the current block (1001), the current block (1001) is predicted based on the intra prediction mode from the MPM lost and the multi-reference-line (1021C).

In the FIG. 10D example, when the multi-reference-line index of the current block (1001) indicates the multi-reference-line (1021D), then the template (1011D) corresponding to the multi-reference-line (1021D) is used to derive one or more intra prediction modes (e.g., according to histogram of gradients in the template). The one or more intra prediction modes can be inserted in the MPM list in an example. Also, in an example, after an intra prediction mode from the MPM list is determined for coding the current block (1001), the current block (1001) is predicted based on the intra prediction mode from the MPM lost and the multi-reference-line (1021D).

In some aspects, when the selected multi-reference-line is not within any of the predefined templates, the most probable mode list is built without the intra prediction modes (also referred to as intra modes in some examples) derived by histogram of gradients from the predefined templates. In some examples, when the selected multi-reference-line is not within any of the predefined templates, the predefined templates are not used to derive the intra prediction modes.

In some aspects, the derived intra prediction mode from a selected template (e.g., corresponding to the selected multi-reference-line) can be used for other coding tools.

In some examples, the derived intra prediction mode from a selected template can be used to determine a transform set. In an example, the determination of the transform set is based on a predefined table that stores a mapping relationship between the intra prediction modes and the transform sets. In some examples, the derived intra prediction mode can be used to determine a primary transform set. In some examples, the derived intra prediction mode can be used to determine a secondary transform set.

In some examples, the derived intra mode from a selected template (e.g., corresponding to the selected multi-reference-line) can be used to determine a direct mode for chroma prediction mode. For example, an intra prediction mode is derived based on luma samples of a selected template, the derived intra prediction mode can be used as a chroma prediction mode that is used to predict the chroma samples of the current block.

In some examples, the derived intra mode from a selected template (e.g., corresponding to the selected multi-reference-line) can be used to predict an intra predictor for the combined inter-intra predictor. In an example, the current block is coded in combined inter-intra prediction (CIIP) mode that is predicted as a combination of an inter predictor and an intra predictor. The derived intra prediction mode from the selected template can be used to generate an intra predictor for the CIIP mode.

According to some aspects of the disclosure, predictors from different templates can be combined as a final predictor.

In some aspects, plural predictors from different templates can be combined as the final prediction. For example, a first template and a second template are used. First one or more predictors are determined based on the first template, and second one or more predictors are determined based on the second template. The first one or more predictors and the second one or more predictors are combined to be a final predictor.

In an example, predictors by the first mode from each template can be combined as the final predictor. For example, a first template and a second template of a current block are used. Based on histogram of gradients of the first template, a first intra prediction mode corresponding to the highest frequency gradient in the histogram is determined. Based on histogram of gradients of the second template, a second intra prediction mode corresponding to the highest frequency gradient in the histogram is determined. In an example, a first predictor of the current block is generated based on the first intra prediction mode and a second predictor of the current block is generated based on the second prediction mode. The first predictor and the second predictor are combined, such as averaged, to be a final predictor.

In another example, predictors by the first N modes from each template can be combined as the final predictor, N is positive integer. For example, a first template and a second template of a current block are used. Based on histogram of gradients of the first template, a first intra prediction mode and a second intra prediction mode corresponding to the two highest frequency gradients in the histogram are determined. Based on histogram of gradients of the second template, a third intra prediction mode and a fourth intra prediction modes corresponding to the two highest frequency gradients in the histogram are determined. In an example, a first predictor of the current block is generated based on the first intra prediction mode, a second predictor of the current block is generated based on the second prediction mode, a third predictor of the current block is generated based on the third intra prediction mode, a fourth predictor of the current block is generated based on the fourth prediction mode. The first predictor, the second predictor, the third predictor, and the fourth predictor are combined, such as averaged, to be a final predictor.

In another embodiment, plural predictors from different templates can be combined in a weighted sum according to the distance between the current block and template. In one example, as the distance increases, a lower weight can be assigned.

For example, a first template and a second template of a current block are used. The first template is closer to the current block than the second template. Based on histogram of gradients of the first template, a first intra prediction mode corresponding to the highest frequency gradient in the histogram is determined. Based on histogram of gradients of the second template, a second intra prediction mode corresponding to the highest frequency gradient in the histogram is determined. In an example, a first predictor of the current block is generated based on the first intra prediction mode and a second predictor of the current block is generated based on the second prediction mode. A weighted sum of the first predictor and the second predictor is calculated to be a final predictor. The first predictor is weighted by a first weight value, and the second predictor is weighted by a second weight value. The first weight value is larger than the second weight value in an example.

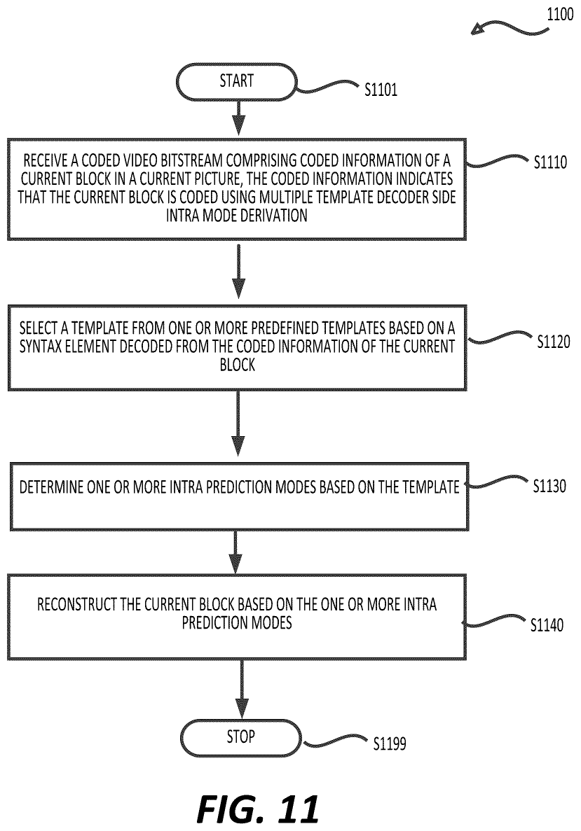

FIG. 11 shows a flow chart outlining a process (1100) according to an aspect of the disclosure. The process (1100) can be used in a video decoder. In various aspects, the process (1100) is executed by processing circuitry, such as the processing circuitry that performs functions of the video decoder (110), the processing circuitry that performs functions of the video decoder (210), and the like. In some aspects, the process (1100) is implemented in software instructions, thus when the processing circuitry executes the software instructions, the processing circuitry performs the process (1100). The process starts at (S1101) and proceeds to (S1110).

At (S1110), a coded video bitstream is received, the coded video bitstream includes coded information of a current block in a current picture, the coded information indicates that the current block is coded using multiple template decoder side intra mode derivation

At (S1120), a template is selected from one or more predefined templates based on a syntax element that is decoded from the coded information of the current block.

At (S1130), one or more intra prediction modes are determined based on the template.

At (S1140), the current block is reconstructed based on the one or more intra prediction modes.

In some aspects, the syntax element is a reference line index indicating a reference line that is selected from a plurality of reference lines. In some examples, a first number of the one or more predefined templates is equal to or less than a second number of the plurality of reference lines.

In some examples, the template is selected based on a position relationship of the one or more predefined templates and the plurality of reference lines. In an example, the reference line is positioned at a nearest line in the template to the current block. In another example, the reference line is positioned at a second nearest line in the template to the current block. In another example, the reference line is positioned at a furthest line in the template to the current block.

In some examples, the template is selected based on a predefined relationship of the one or more predefined templates and the plurality of reference lines. The current block is reconstructed according to reference samples in the reference line.

In some aspects, the syntax element is a template index indicating the template that is selected from the one or more predefined templates.

In some examples, to determine the one or more intra prediction modes, a histogram of gradients is constructed from samples in the template; and the one or more intra prediction modes are determined based on the histogram of gradients.

In some examples, a transform set is determined based on the one or more intra prediction modes, and residual values of the current block are calculated based on the transform set. For example, transform coefficients are decoded from the coded information, and inverse transform is applied on the transform coefficients using the transform set to calculate the residual values of the current block. The residual values of the current block can be combined with the predictor of the current block to reconstruct the current block.

In some examples, the one or more intra prediction modes are determined based on luma values of first samples in the template. Luma values of second samples in the current block can be constructed based on the one or more intra prediction modes. Also, chroma values of the second samples in the current block can be reconstructed using a direct mode (DM) that is determined according to the one or more intra prediction modes (e.g., intra prediction mode of the collocated luma block).

In some examples, an intra predictor of the current block is generated based on the one or more intra prediction modes, the current block is coded in a combined inter-intra prediction mode. The intra predictor can be combined with an inter predictor of the current block to reconstruct the current block.

In some examples, at least a first template and a second template that are different from each other are selected. A first predictor of the current block is generated based on first one or more intra prediction modes derived based on the first template. A second predictor of the current block is generated based on second one or more intra prediction modes derived based on the second template. The first predictor and the second predictor are combined to calculate a final predictor of the current block.

In some examples, at least a first template and a second template that are different from each other are selected. First predictors of the current block are generated based on first intra prediction modes derived from the first template, and second predictors of the current block are generated based on second intra prediction modes derived from the second template. The first predictors and the second predictors are combined to calculate a final predictor of the current block.

In some examples, at least a first template and a second template that are different from each other are selected, the first template has a first distance to the current block, the second template has a second distance to the current block. A first predictor of the current block is generated based on first one or more intra prediction modes derived based on the first template, and a second predictor of the current block is generated based on second one or more intra prediction modes derived based on the second template. A weighted sum of the first predictor and the second predictor is calculated as a final predictor for the current block, the first predictor is weighted based on the first distance, and the second predictor is weighted based on the second distance. In an example, the first predictor is weighted by a first weight, the second predictor is weighted by a second weight, the first weight is higher than the second weight.

Then, the process proceeds to (S1199) and terminates.

The process (1100) can be suitably adapted. Step(s) in the process (1100) can be modified and/or omitted. Additional step(s) can be added. Any suitable order of implementation can be used.

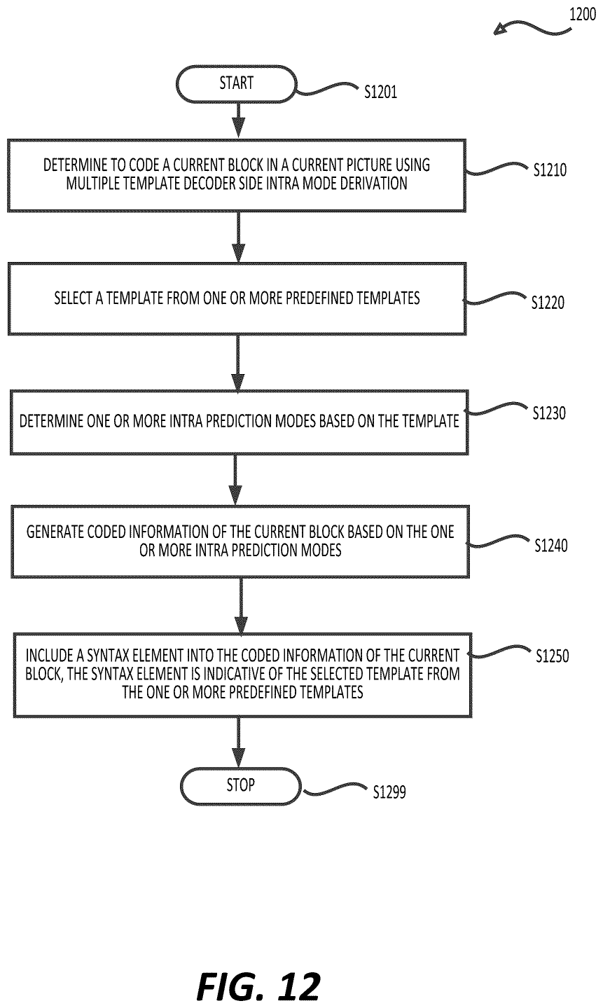

FIG. 12 shows a flow chart outlining a process (1200) according to an aspect of the disclosure. The process (1200) can be used in a video encoder. In various aspects, the process (1200) is executed by processing circuitry, such as the processing circuitry that performs functions of the video encoder (103), the processing circuitry that performs functions of the video encoder (303), and the like. In some aspects, the process (1200) is implemented in software instructions, thus when the processing circuitry executes the software instructions, the processing circuitry performs the process (1200). The process starts at (S1201) and proceeds to (S1210).

At (S1210), to code a current block in a current picture using multiple template decoder side intra mode derivation is determined.

At (S1220), a template is selected from one or more predefined templates.

At (S1230), one or more intra prediction modes are determined based on the template.

At (S1240), coded information of the current block is generated based on the one or more intra prediction modes.

At (S1250), a syntax element is included into the coded information of the current block, the syntax element is indicative of the selected template from the one or more predefined templates.

In some aspects, the syntax element is a reference line index that indicates a reference line selected from a plurality of reference lines. In some examples, a first number of the one or more predefined templates is equal to or less than a second number of the plurality of reference lines. The one or more predefined templates can be mapped to the plurality of reference lines.

In some examples, the reference line can be positioned at one of a nearest line in the template to the current block, a second nearest line in the template to the current block; or a furthest line in the template to the current block.

In some examples, to generate the coded information, a predictor of the current block is generated according to reference samples in the reference line.

In some aspects, the syntax element is a template index indicating the template that is selected from the one or more predefined templates.

In some examples, to determine the one or more intra prediction modes, a histogram of gradients is constructed from samples in the template, and the one or more intra prediction modes based on the histogram of gradients.

In some examples, a transform set is determined based on the one or more intra prediction modes derived from the template, and residual values of the current block are encoded based on the transform set.

In some examples, the one or more intra prediction modes are determined based on luma values of first samples in the template. To generate the coded information of the current block, predicted chroma values of second samples in the current block are generated using a direct mode that is determined according to the one or more intra prediction modes.

In some examples, the current block is coded in a combined inter-intra prediction mode, an intra predictor of the current block is generated based on the one or more intra prediction modes, and a final predictor of the current block is calculated as a combination of the intra predictor with an inter predictor of the current block.

In some examples, at least a first template and a second template that are different from each other are selected. A first predictor of the current block is generated based on first one or more intra prediction modes derived based on the first template, a second predictor of the current block is generated based on second one or more intra prediction modes derived based on the second template, and the first predictor and the second predictor are combined to calculate a final predictor of the current block.

In some examples, at least a first template and a second template that are different from each other are selected. First predictors of the current block are generated based on the first template. Second predictors of the current block are generated based on the second template. The first predictors and the second predictors are combined to calculate a final predictor of the current block.

In some examples, at least a first template and a second template that are different from each other are selected. The first template has a first distance to the current block, the second template has a second distance to the current block. A first predictor of the current block is generated based on first one or more intra prediction modes derived based on the first template. A second predictor of the current block is generated based on second one or more intra prediction modes derived based on the second template. A weighted sum of the first predictor and the second predictor is calculated as a final predictor for the current block, the first predictor is weighted based on the first distance, and the second predictor is weighted based on the second distance. In an example, the first predictor is weighted by a first weight, the second predictor is weighted by a second weight, the first weight is higher than the second weight.

Then, the process proceeds to (S1299) and terminates.

The process (1200) can be suitably adapted. Step(s) in the process (1200) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes coded information of a current block in a current picture, the coded information indicates that the current block is coded using multiple template decoder side intra mode derivation. The format rule specifies that a template is selected from one or more predefined templates based on a syntax element in the coded information of the current block; one or more intra prediction modes is determined based on the template; and the current block is reconstructed based on the one or more intra prediction modes.

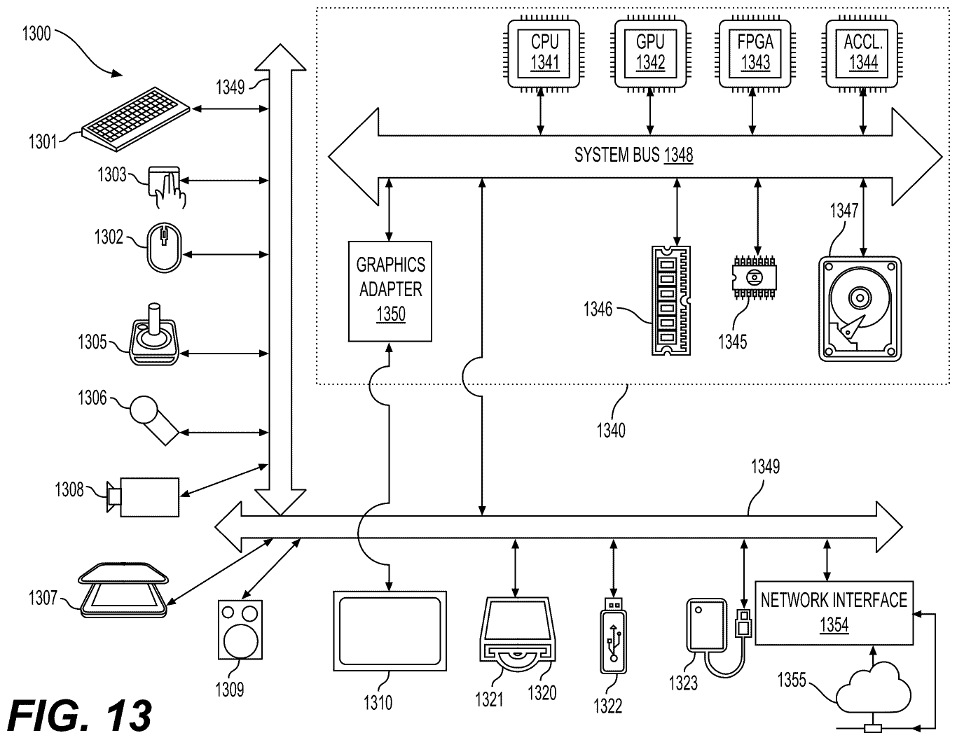

The techniques described above, can be implemented as computer software using computer-readable instructions and physically stored in one or more computer-readable media. For example, FIG. 13 shows a computer system (1300) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 13 for computer system (1300) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1300).

Computer system (1300) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1301), mouse (1302), trackpad (1303), touch screen (1310), data-glove (not shown), joystick (1305), microphone (1306), scanner (1307), camera (1308).

Computer system (1300) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1310), data-glove (not shown), or joystick (1305), but there can also be tactile feedback devices that do not serve as input devices), audio output devices (such as: speakers (1309), headphones (not depicted)), visual output devices (such as screens (1310) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1300) can also include human accessible storage devices and their associated media such as optical media including CD/DVD ROM/RW (1320) with CD/DVD or the like media (1321), thumb-drive (1322), removable hard drive or solid state drive (1323), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1300) can also include an interface (1354) to one or more communication networks (1355). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1349) (such as, for example USB ports of the computer system (1300)); others are commonly integrated into the core of the computer system (1300) by attachment to a system bus as described below (for example Ethernet interface into a PC computer system or cellular network interface into a smartphone computer system). Using any of these networks, computer system (1300) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1340) of the computer system (1300).

The core (1340) can include one or more Central Processing Units (CPU) (1341), Graphics Processing Units (GPU) (1342), specialized programmable processing units in the form of Field Programmable Gate Areas (FPGA) (1343), hardware accelerators for certain tasks (1344), graphics adapters (1350), and so forth. These devices, along with Read-only memory (ROM) (1345), Random-access memory (1346), internal mass storage such as internal non-user accessible hard drives, SSDs, and the like (1347), may be connected through a system bus (1348). In some computer systems, the system bus (1348) can be accessible in the form of one or more physical plugs to enable extensions by additional CPUs, GPU, and the like. The peripheral devices can be attached either directly to the core's system bus (1348), or through a peripheral bus (1349). In an example, the screen (1310) can be connected to the graphics adapter (1350). Architectures for a peripheral bus include PCI, USB, and the like.

CPUs (1341), GPUs (1342), FPGAs (1343), and accelerators (1344) can execute certain instructions that, in combination, can make up the aforementioned computer code. That computer code can be stored in ROM (1345) or RAM (1346). Transitional data can also be stored in RAM (1346), whereas permanent data can be stored for example, in the internal mass storage (1347). Fast storage and retrieve to any of the memory devices can be enabled through the use of cache memory, that can be closely associated with one or more CPU (1341), GPU (1342), mass storage (1347), ROM (1345), RAM (1346), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1300), and specifically the core (1340) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1340) that are of non-transitory nature, such as core-internal mass storage (1347) or ROM (1345). The software implementing various aspects of the present disclosure can be stored in such devices and executed by core (1340). A computer-readable medium can include one or more memory devices or chips, according to particular needs. The software can cause the core (1340) and specifically the processors therein (including CPU, GPU, FPGA, and the like) to execute particular processes or particular parts of particular processes described herein, including defining data structures stored in RAM (1346) and modifying such data structures according to the processes defined by the software. In addition or as an alternative, the computer system can provide functionality as a result of logic hardwired or otherwise embodied in a circuit (for example: accelerator (1344)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1). A method of video decoding, including: receiving a coded video bitstream including coded information of a current block in a current picture, the coded information indicating that the current block is coded using multiple template decoder side intra mode derivation; selecting a template from one or more predefined templates based on a syntax element that is decoded from the coded information of the current block; determining one or more intra prediction modes based on the template; and reconstructing the current block based on the one or more intra prediction modes.
(2). The method of feature (1), in which the syntax element is a reference line index indicating a reference line that is selected from a plurality of reference lines.
(3). The method of any of features (1) to (2), in which: a first number of the one or more predefined templates is equal to or less than a second number of the plurality of reference lines.
(4). The method of any of features (1) to (3), in which the selecting the template includes: selecting the template based on a position relationship of the one or more predefined templates and the plurality of reference lines.
(5). The method of any of features (1) to (4), in which the reference line is positioned at one of: a nearest line in the template to the current block; a second nearest line in the template to the current block; or a furthest line in the template to the current block.
(6). The method of any of features (1) to (5), in which: the selecting the template includes: selecting the template based on a predefined relationship of the one or more predefined templates and the plurality of reference lines; and the reconstructing the current block includes: reconstructing the current block according to reference samples in the reference line.
(7). The method of any of features (1) to (6), in which the syntax element is a template index indicating the template that is selected from the one or more predefined templates.
(8). The method of any of features (1) to (7), in which the determining the one or more intra prediction modes includes: constructing a histogram of gradients from samples in the template; and selecting the one or more intra prediction modes based on the histogram of gradients.
(9). The method of any of features (1) to (8), further including: determining a transform set based on the one or more intra prediction modes; and calculating residual values of the current block based on the transform set.
(10). The method of any of features (1) to (9), in which: the determining the one or more intra prediction modes includes: determining the one or more intra prediction modes based on luma values of first samples in the template; and the reconstructing the current block includes: reconstructing luma values of second samples in the current block based on the one or more intra prediction modes; and reconstructing chroma values of the second samples in the current block using a direct mode that is determined according to the one or more intra prediction modes.
(11). The method of any of features (1) to (10), in which the reconstructing the current block includes: generating an intra predictor of the current block based on the one or more intra prediction modes, the current block being coded in a combined inter-intra prediction mode; and combining the intra predictor with an inter predictor of the current block to reconstruct the current block.
(12). The method of any of features (1) to (11), in which: the selecting the template includes: selecting at least a first template and a second template that are different from each other; and the reconstructing the current block includes: generating a first predictor of the current block based on first one or more intra prediction modes derived based on the first template; generating a second predictor of the current block based on second one or more intra prediction modes derived based on the second template; and combining the first predictor and the second predictor to calculate a final predictor of the current block.
(13). The method of any of features (1) to (12), in which: the selecting the template includes: selecting at least a first template and a second template that are different from each other; and the reconstructing the current block includes: generating first predictors of the current block based on the first template; generating second predictors of the current block based on the second template; and combining the first predictors and the second predictors to calculate a final predictor of the current block.
(14). The method of any of features (1) to (13), in which: the selecting the template includes: selecting at least a first template and a second template that are different from each other, the first template having a first distance to the current block, the second template having a second distance to the current block; and the reconstructing the current block includes: generating a first predictor of the current block based on first one or more intra prediction modes derived based on the first template; generating a second predictor of the current block based on second one or more intra prediction modes derived based on the second template; and calculating a weighted sum of the first predictor and the second predictor as a final predictor for the current block, the first predictor being weighted based on the first distance, and the second predictor being weighted based on the second distance.
(15). The method of any of features (1) to (14), in which the first predictor is weighted by a first weight, the second predictor is weighted by a second weight, the first weight is higher than the second weight.
(16). A method of video encoding, including: determining to code a current block in a current picture using multiple template decoder side intra mode derivation; selecting a template from one or more predefined templates; determining one or more intra prediction modes based on the template; generating coded information of the current block based on the one or more intra prediction modes; and including a syntax element into the coded information of the current block, the syntax element being indicative of the selected template from the one or more predefined templates.
(17). The method of feature (16), in which the syntax element is a reference line index that indicates a reference line selected from a plurality of reference lines.
(18). The method of any of features (16) to (17), in which: a first number of the one or more predefined templates is equal to or less than a second number of the plurality of reference lines.
(19). The method of any of features (16) to (18), in which the one or more predefined templates are mapped to the plurality of reference lines.
(20). The method of any of features (16) to (19), in which the reference line is positioned at one of: a nearest line in the template to the current block; a second nearest line in the template to the current block; or a furthest line in the template to the current block.
(21). The method of any of features (16) to (20), in which the generating the coded information includes: generating a predictor of the current block according to reference samples in the reference line.
(22). The method of any of features (16) to (21), in which the syntax element is a template index indicating the template that is selected from the one or more predefined templates.
(23). The method of any of features (16) to (22), in which the determining the one or more intra prediction modes includes: constructing a histogram of gradients from samples in the template; and selecting the one or more intra prediction modes based on the histogram of gradients.
(24). The method of any of features (16) to (23), further including: determining a transform set based on the one or more intra prediction modes derived from the template; and encoding residual values of the current block based on the transform set.
(25). The method of any of features (16) to (24), in which: the determining the one or more intra prediction modes includes: determining the one or more intra prediction modes based on luma values of first samples in the template; and the generating the coded information of the current block includes: generating predicted chroma values of second samples in the current block using a direct mode that is determined according to the one or more intra prediction modes.
(26). The method of any of features (16) to (25), in which the generating the coded information of the current block includes: generating an intra predictor of the current block based on the one or more intra prediction modes, the current block being coded in a combined inter-intra prediction mode; and generating a final predictor of the current block as a combination of the intra predictor with an inter predictor of the current block.
(27). The method of any of features (16) to (26), in which: the selecting the template includes: selecting at least a first template and a second template that are different from each other; and the generating the coded information of the current block includes: generating a first predictor of the current block based on first one or more intra prediction modes derived based on the first template; generating a second predictor of the current block based on second one or more intra prediction modes derived based on the second template; and combining the first predictor and the second predictor to calculate a final predictor of the current block.
(28). The method of any of features (16) to (27), in which: the selecting the template includes: selecting at least a first template and a second template that are different from each other; and the generating the coded information of the current block includes: generating first predictors of the current block based on the first template; generating second predictors of the current block based on the second template; and combining the first predictors and the second predictors to calculate a final predictor of the current block.
(29). The method of any of features (16) to (28), in which: the selecting the template includes: selecting at least a first template and a second template that are different from each other, the first template having a first distance to the current block, the second template having a second distance to the current block; and the generating the coded information of the current block includes: generating a first predictor of the current block based on first one or more intra prediction modes derived based on the first template; generating a second predictor of the current block based on second one or more intra prediction modes derived based on the second template; and calculating a weighted sum of the first predictor and the second predictor as a final predictor for the current block, the first predictor being weighted based on the first distance, and the second predictor being weighted based on the second distance.
(30). The method of any of features (16) to (29), in which the first predictor is weighted by a first weight, the second predictor is weighted by a second weight, the first weight is higher than the second weight.
(31). A method of processing visual media data, the method including: processing a bitstream of visual media data according to a format rule, in which: the bitstream includes coded information of a current block in a current picture, the coded information indicating that the current block is coded using multiple template decoder side intra mode derivation; and the format rule specifies that: a template is selected from one or more predefined templates based on a syntax element in the coded information of the current block; one or more intra prediction modes is determined based on the template; and the current block is reconstructed based on the one or more intra prediction modes.
(32). An apparatus for video decoding, including processing circuitry that is configured to perform the method of any of features (1) to (15).
(33). An apparatus for video encoding, including processing circuitry that is configured to perform the method of any of features (16) to (30).
(34). A non-transitory computer-readable storage medium storing instructions which when executed by at least one processor cause the at least one processor to perform the method of any of features (1) to (31).

What is claimed is:

1. A method of video decoding, comprising:
receiving a coded video bitstream comprising coded information of a current block in a current picture, the coded information indicating that the current block is coded using multiple template decoder side intra mode derivation;
selecting a template from one or more predefined templates based on a syntax element that is decoded from the coded information of the current block;
determining one or more intra prediction modes based on the template; and
reconstructing the current block based on the one or more intra prediction modes.

2. The method of claim 1, wherein the syntax element is a reference line index indicating a reference line that is selected from a plurality of reference lines.

3. The method of claim 2, wherein:
a first number of the one or more predefined templates is equal to or less than a second number of the plurality of reference lines.

4. The method of claim 2, wherein the selecting the template comprises:
selecting the template based on a position relationship of the one or more predefined templates and the plurality of reference lines.

5. The method of claim 4, wherein the reference line is positioned at one of:
a nearest line in the template to the current block;
a second nearest line in the template to the current block; or
a furthest line in the template to the current block.

6. The method of claim 2, wherein:
the selecting the template comprises:
selecting the template based on a predefined relationship of the one or more predefined templates and the plurality of reference lines; and
the reconstructing the current block comprises:
reconstructing the current block according to reference samples in the reference line.

7. The method of claim 1, wherein the syntax element is a template index indicating the template that is selected from the one or more predefined templates.

8. The method of claim 1, wherein the determining the one or more intra prediction modes comprises:
constructing a histogram of gradients from samples in the template; and
selecting the one or more intra prediction modes based on the histogram of gradients.

9. The method of claim 1, further comprising:
determining a transform set based on the one or more intra prediction modes; and
calculating residual values of the current block based on the transform set.

10. The method of claim 1, wherein:
the determining the one or more intra prediction modes comprises:
determining the one or more intra prediction modes based on luma values of first samples in the template; and
the reconstructing the current block comprises:
reconstructing luma values of second samples in the current block based on the one or more intra prediction modes; and
reconstructing chroma values of the second samples in the current block using a direct mode that is determined according to the one or more intra prediction modes.

11. The method of claim 1, wherein the reconstructing the current block comprises:
generating an intra predictor of the current block based on the one or more intra prediction modes, the current block being coded in a combined inter-intra prediction mode; and
combining the intra predictor with an inter predictor of the current block to reconstruct the current block.

12. The method of claim 1, wherein:
the selecting the template comprises:
selecting at least a first template and a second template that are different from each other; and
the reconstructing the current block comprises:
generating a first predictor of the current block based on first one or more intra prediction modes derived based on the first template;
generating a second predictor of the current block based on second one or more intra prediction modes derived based on the second template; and
combining the first predictor and the second predictor to calculate a final predictor of the current block.

13. The method of claim 1, wherein:
the selecting the template comprises:
selecting at least a first template and a second template that are different from each other; and
the reconstructing the current block comprises:
generating first predictors of the current block based on the first template;
generating second predictors of the current block based on the second template; and
combining the first predictors and the second predictors to calculate a final predictor of the current block.

14. The method of claim 1, wherein:
the selecting the template comprises:
selecting at least a first template and a second template that are different from each other, the first template having a first distance to the current block, the second template having a second distance to the current block; and
the reconstructing the current block comprises:
generating a first predictor of the current block based on first one or more intra prediction modes derived based on the first template;
generating a second predictor of the current block based on second one or more intra prediction modes derived based on the second template; and
calculating a weighted sum of the first predictor and the second predictor as a final predictor for the current block, the first predictor being weighted based on the first distance, and the second predictor being weighted based on the second distance.

15. The method of claim 14, wherein the first predictor is weighted by a first weight, the second predictor is weighted by a second weight, the first weight is higher than the second weight.

16. A method of video encoding, comprising:
determining to code a current block in a current picture using multiple template decoder side intra mode derivation;
selecting a template from one or more predefined templates;
determining one or more intra prediction modes based on the template;
generating coded information of the current block based on the one or more intra prediction modes; and
including a syntax element into the coded information of the current block, the syntax element being indicative of the selected template from the one or more predefined templates.

17. The method of claim 16, wherein the syntax element is a reference line index that indicates a reference line selected from a plurality of reference lines.

18. The method of claim 17, wherein:
a first number of the one or more predefined templates is equal to or less than a second number of the plurality of reference lines.

19. The method of claim 17, wherein the one or more predefined templates are mapped to the plurality of reference lines.

20. A method of processing visual media data, the method comprising:
processing a bitstream of visual media data according to a format rule, wherein:
the bitstream includes coded information of a current block in a current picture, the coded information indicating that the current block is coded using multiple template decoder side intra mode derivation; and
the format rule specifics that:
a template is selected from one or more predefined templates based on a syntax element in the coded information of the current block;
one or more intra prediction modes is determined based on the template: and
the current block is reconstructed based on the one or more intra prediction modes.
